(19) United States
(12) Patent Application Publication
(10) Pub. No.: US 2009/0277054 A1
(43) Pub. Date: Nov. 12, 2009

(54) CALENDAR FOR RECORDING REGULAR EVENTS

(76) Inventor: Sharon Neiss, Toronto (CA)

Correspondence Address: MILLER THOMPSON, LLP, Scotia Plaza, 40 King Street West, Suite 5800, TORONTO, ON, M5H 3S1, CA

(21) Appl. No.: 12/436,340

(22) Filed: May 6, 2009

Related U.S. Application Data
(60) Provisional application No. 61/050,734, filed on May 6, 2008.

(51) Int. Cl. G09D 3/00

(52) U.S. Cl. 40/107

(57) ABSTRACT

The reoccurring event calendar system is formed of at least one overlay piece and at least one underlay piece. The at least one overlay piece may have holes or windows cut therein whereby portions of the at least one underlay piece is visible and accessible when the overlay piece is positioned above the underlay piece. The windows may correspond to periods of time and such periods of time may be marked on either the underlay or overlay pieces. Alignment of the overlay pieces and underlay pieces facilitate marking and visibility of non-reoccurring events and reoccurring events. If reoccurring events are marked upon the overlay piece it may be utilized with multiple underlay pieces, or if reoccurring events are marked upon the underlay piece it may be utilized with multiple overlay pieces. Events may be marked in a code for easy recognition of events corresponding to specific categories.

This application claims the benefit of U.S. Provisional Patent Application Ser. No. 61/050,734 filed May 6, 2008.

### FIELD OF INVENTION

This invention relates in general to the field of a calendar system and more particularly to a calendar for recording reoccurring and non-reoccurring events.

### BACKGROUND OF THE INVENTION

Calendar systems of a variety of types allowing for the association of particular events with specific dates are well-known and widely-utilized. Some calendars create this association by allowing events to be written on a calendar page surface and thereby be associated with a specific day and date of a given year (or another period of time, depending on the calendar layout). Other calendars facilitate this association through the notation of events on a calendar whereby events are associated with specific dates that are constant from year to year. Such dates may fall on different days in different years. By marking an event for a specific date the calendar can be used to indicate the date of a particular event on a repetitive annual basis. For example, birthday calendars may function in this manner.

Still other calendar systems attempt to co-join both functionalities. For example, US Patent Application No. 2005/0082817 discloses a calendar having two parts. A first part displays a calendar and permits the notation of particular events corresponding to specific dates, such as January 29. A second part is a calendar displaying dates as particular days in a given year, for example, Tuesday, Jan. 29, 2008. The first calendar can be searched for particular events happening upon specific dates. The day corresponding to that date in a particular year may be shown in the second calendar. The events recorded in the first part can be written onto the second part. Display of the two calendars simultaneously may create an ease of reference between the calendar parts.

Other calendar systems involve layering pieces to create a whole calendar. For example, U.S. Pat. No. 5,135,260 discloses a multi-layer structure that aims to create an aesthetically pleasing calendar.

Other multi-layer calendars function so that the date and day are adjustable in a manner capable of creating a perpetual calendar. For example, US Patent Application No. 2003/0182826 discloses a perpetual calendar in a wheel-form, having inner and outer wheel sections. Dates are included on the inner wheel, whereas information relating to those dates is included on the outer wheel. For the purpose of this patent application the wheel and the information display are constructed specifically to allow an expectant mother to track her gestation period through the rotation of the wheel.

U.S. Pat. No. 5,003,713 is another example of a layered perpetual calendar. It can be either wheel-shaped or rectangular-shaped and the alignment of dates and days for particular years may be achieved through the application of a colour-key system.

U.S. Pat. No. 5,930,924 is a further perpetual calendar formed of a sleeve wherein a sheet may be placed. The sleeve may have windows therein and a year calendar may be printed on the sheet that is placed inside the sleeve in a manner that is moveably adjustable to display dates and days relating to particular months through the windows.

None of the above-referenced systems are able to address the need to mark specific regular, reoccurring events upon a calendar in a consistent and easy manner.

US Patent Application No. 2007/0126225 attempts to address this problem. This patent application discloses an insert that may be utilized with a calendar formed as multiple bound pages. The insert may be moved to overlay a particular page in a removeably attached manner. The insert may be formed of transparent material and thus it may be possible to write upon the insert in a manner whereby the writing corresponds with a particular section of the calendar page it overlays. When moved to another page having the same calendar layout (whether it displays a day, a week, a month, etc.), the insert will associate the information written upon it to the page it now overlays. Thereby reoccurring reminders can be noted once and caused to correspond with multiple days and/or dates. Although this invention does allow for an ease of recording reoccurring reminders, it still embodies certain flaws, including an inability to record both reoccurring and non-reoccurring events upon a calendar system.

### SUMMARY OF THE INVENTION

In one aspect, the present disclosure relates to a reoccurring event calendar system comprising: at least one underlay piece; at least one overlay piece having one or more windows therein, said one or more windows corresponding to periods of time, the at least one overlay piece being positioned over the at least one underlay piece so that portions of the at least one underlay piece are accessible through the one or more windows; and a marking means for marking one or more reoccurring events to correspond to the periods of time by: marking the one or more reoccurring events on the at least one underlay piece to be visible through at least one of the one or more windows; or marking the one or more reoccurring events one the at least one overlay piece to correspond to at least one of the one or more windows; whereby the one or more reoccurring events correspond to a period of time.

In another aspect, the present disclosure relates to a reoccurring event calendar system comprising: one or more underlay pieces having a calendar printed thereon; and an overlay piece having one or more windows corresponding to the calendar of the underlay piece and providing one or more areas corresponding to the one or more windows capable of having markings of one or more reoccurring events made thereon corresponding to the one or more windows; whereby the one or more marked reoccurring events correspond to the calendar printed on the one or more underlay pieces when the overlay piece is positioned over at least one of the one or more underlay pieces and aligned therewith.

In yet another aspect, the present disclosure relates to a reoccurring event calendar system comprising: one or more overlay pieces having a calendar printed thereon and having one or more windows corresponding to the calendar; and an underlay piece capable of having markings of one or more reoccurring events made thereon positioned to be visible through at least one of the one or more windows when at least one of the overlay pieces is positioned over the underlay piece and aligned therewith; whereby the marking of the one or more reoccurring events correspond to the calendar printed on the one or more overlay pieces.

In another aspect, the present disclosure relates to a method of utilizing a reoccurring event calendar system comprising the steps of: marking one or more reoccurring events upon an overlay piece to correspond with one or more windows therein; aligning at least one underlay piece having a calendar printed thereon with the overlay piece so that the one or more reoccurring events marked upon the overlay piece correspond to the calendar printed upon the underlay piece; and viewing the one or more reoccurring events marked upon the overlay piece as corresponding to the calendar of the at least one underlay piece visible through the one or more windows of the overlay piece.

In another aspect, the present disclosure relates to a method of utilizing a reoccurring event calendar system comprising the steps of: receiving at least one overlay piece having a calendar printed thereon and windows therein corresponding to the calendar; marking one or more reoccurring events upon an underlay piece to correspond with one or more windows therein so as to be visible through at least one of the one or more windows; aligning at least one of the one or more overlay pieces with the underlay piece so that the one or more reoccurring events marked upon the overlay piece correspond to the calendar printed upon the underlay piece; and viewing the one or more reoccurring events marked upon the underlay piece as corresponding to the calendar of the at least one underlay piece visible through the one or more windows of the overlay piece.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a front perspective view of the calendar system.

FIG. 2 is a front view of the underlay section.

FIG. 3 is a front view of the overlay section.

FIG. 4 is a front perspective view of the calendar system.

FIG. 5 is cross-sectional depiction of the calendar system.

FIG. 6 is a sectional front view showing the calendar underlay and overlay sections.

FIG. 7 is a front view of the calendar system.

FIG. 8 is a front view of the calendar system capable of displaying a month of dates.

FIG. 9 is a front view of the calendar system with an indicia section.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

The present invention is a calendar system for recording regular reoccurring events and non-reoccurring events. In particular embodiments the calendar system may facilitate the alignment of particular events reoccurring regularly within a specific measure of time, for example a month, a day, a date, an hour, etc. In another embodiment the present invention further provides for a space wherein non-reoccurring events relating to particular individual periods of time, for example, a month, a day, a date, an hour, etc., may be entered. In yet another embodiment, reoccurring and non-reoccurring events may be indicated according to a set code, such as, for example a code utilizing colours, a code utilizing writing styles, etc., whereby the code used to indicate an event corresponds to a category, such as: a family; a course of study; a holiday season; medical treatment; etc.

The calendar system of the present invention may be formed of at least one overlay piece and at least one underlay piece. The at least one overlay piece having holes or windows cut therein whereby portions of the at least one underlay piece is visible and accessible when the overlay piece is positioned above the underlay piece. The windows may correspond to periods of time and such periods of time may be marked on either the underlay or overlay pieces. Alignment of the overlay pieces and underlay pieces facilitate either: the marking of reoccurring events upon either the overlay piece and non-occurring events upon the underlay piece; or the marking of reoccurring events upon either the overlay piece and non-occurring events upon the underlay piece. Coding of the events may further provide a means for easily recognizing events corresponding to specific categories, such as people, holidays, courses, medical treatment, etc.

The present invention may be utilized to create a calendar system. The calendar system may incorporate either the overlay piece or underlay piece being marked with periods of time, such as, for example years, months, days, hours or other calendar intervals. The piece not marked with calendar intervals may be marked with reoccurring events. For example, in an embodiment of the present invention wherein the overlay piece is marked with calendar intervals, the underlay piece may be marked with reoccurring events. As another example, in an embodiment of the present invention wherein the underlay piece is marked with calendar intervals, the overlay piece may be marked with reoccurring events. Examples of these and other embodiments of the present invention are described herein.

The overlay piece may be formed of a variety of materials, including coated papers, such as wet/dry erase paper, although a variety of other materials may be utilized as well, including fabric, plastic, paper, cardboard, etc. The underlay piece may be formed of any type of paper, including that used in generally-available printed calendars, although any other material capable of having a calendar printed thereupon may also be utilized.

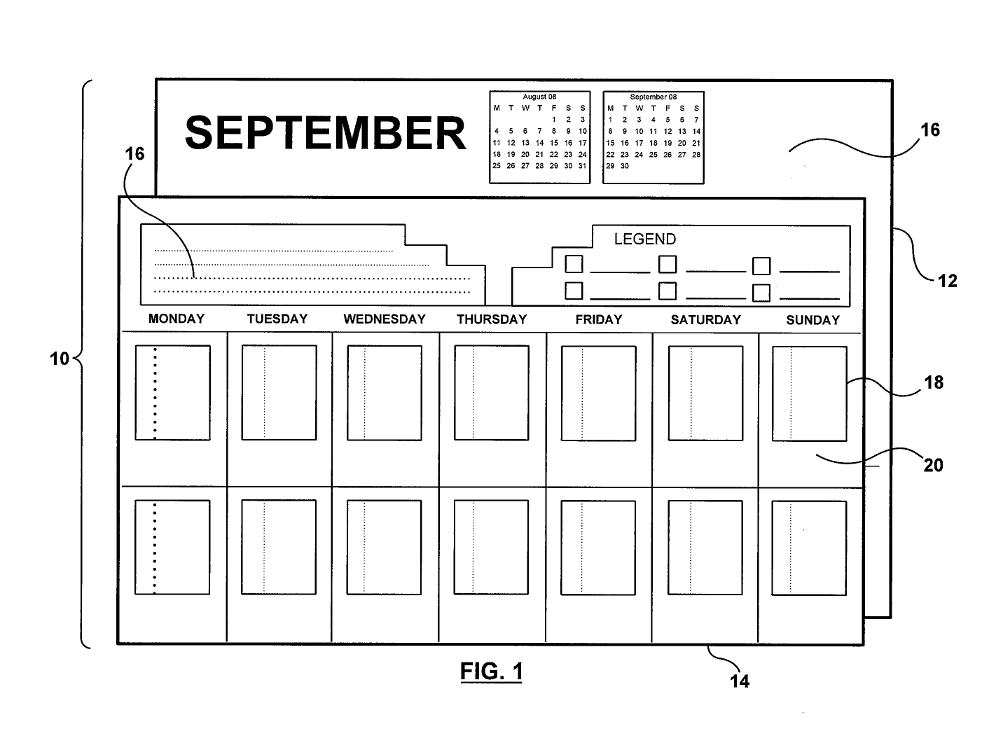

Events indicated upon the overlay piece or underlay piece may correspond to specific dates, times, etc., and these may be shown upon a calendar printed upon either the overlay piece or underlay piece, depending on the embodiment of the present invention. For example, a calendar showing a month segregated into weeks and days may be printed on the overlay piece, as shown in FIG. 1. A person skilled in the art will recognize that other types of time designations may be indicated upon either the overlay piece or the underlay piece, such as, for example, months in a year, hours in a day, etc.

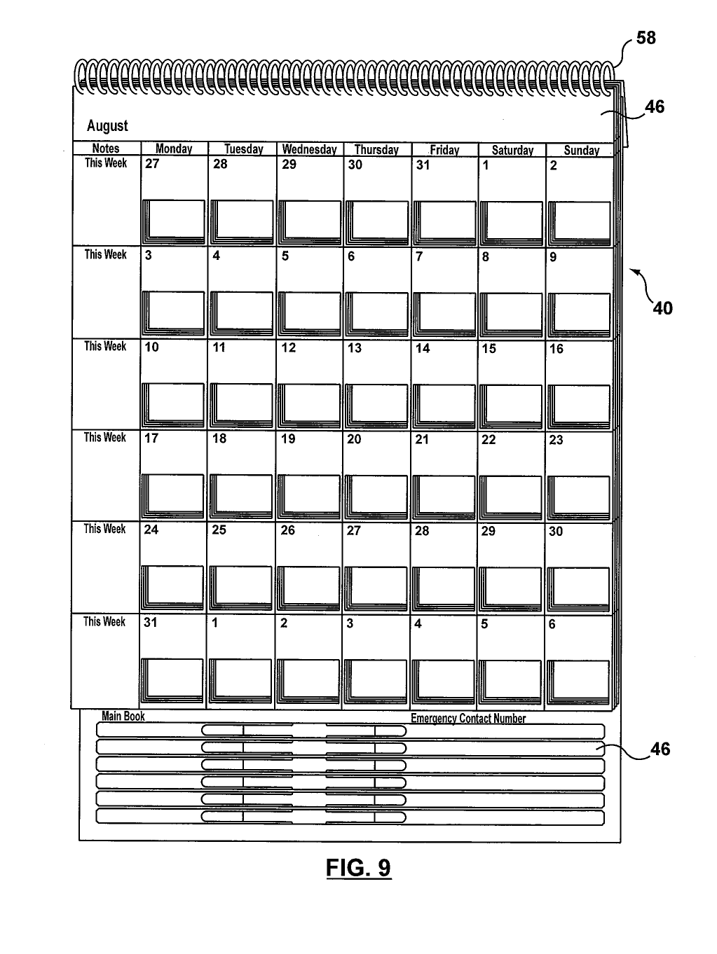

Furthermore, the underlay pieces and overlay pieces may have indicia sections available for the inclusion of additional information or decorative indicia, as shown in FIG. 1 as indicia section 16 and FIG. 9 as indicia section 46. A person skilled in the art will recognize that there are a number of types of decorative or functional indicia that may be included in these sections, for example, a picture, an advertisement, a list of emergency numbers, an grocery list section, a quote, one or more mini calendars, a blank section, or a lined section, as well as elements external to the calendar system may be attached thereto such as, for example, a small pad of paper, or Post-it Notes™. A person skilled in the art will recognize that a variety of elements are attachable to the calendar system.

Indicia sections may be pre-marked during the manufacturing process, or may have a surface that facilitates marking by the owner of the calendar system. An indicia section that facilitates marking may be formed of a material from which markings may be erased. For example, the section may be formed of a material utilized for whiteboards, and a specific pen may be used to write thereupon which is erasable. A person skilled in the art will recognize that a variety of means of marking upon an indicia section, including forming the indicia section from specific materials, or utilizing specific marking means upon the indicia section may render the indicia section erasable.

In one embodiment of the present invention, one of the indicia sections may display a code key that shows a particular code corresponding to events written on the calendar. For example the code may include a colour of text, or a style of writing, etc. This code may pertain to a particular category of events, such as events pertaining to a specific person, events pertaining to a specific course of study, or events pertaining to medical treatment appointments and drug administration, etc. It will be obvious to a skilled reader that many different categories of events may be identified through a variety of codes.

For example, if the calendar is used by a family, each member of the family may be identified in the code key as represented by a specific colour (e.g. Grandma is red, Mom is purple, Junior is green, etc.). Thus, when an event is written on the calendar in a colour it may be identified by the code key as relevant to a particular family member. For example, red writing that may be identified as corresponding to Grandma, and it may be assumed that an event written in red ink is one which is pertinent to Grandma. The allocation of an event to a person may be readily recognized at a glance. So that if a bridge game is noted in red ink it will be easy to recognize that this is an event pertaining to Grandma, whereas a soccer game written in green is pertinent to Junior, and a hair appointment written in purple is for Mom, to offer but one example.

As an additional example, if the calendar is used by a student, the code key may align particular fonts to specific courses that student is taking during a semester. For example, Biology 101 may be assigned the Arial font. Thus, all class times, class assignments and final examinations entered upon the calendar, either on the overlay or underlay sections, written in Arial font may be assumed to pertain to Biology 101. Thus, the use of the code can create a simple means of aligning events with a particular category. The information that the event is aligned with a category is easily understood, through visual acknowledgement or any other means, depending on the code.

The present invention provides benefits over the prior art. For example, the present invention permits the notation of regular reoccurring events in a manner that causes an event to correspond with a specific period of time. The period of time may be expressed in a calendar format. For example, a reoccurring event such as a doctor's appointment the first Wednesday of each month may be noted in a manner that causes that event to correspond with a specific date, such as Wednesday, Jun. 3, 2009. The present invention further facilitates the notation of non-reoccurring information corresponding to a specific time period being displayed, as well the notation of as reoccurring information, without requiring that any of the calendar structure be lifted or removed.

Other benefits of the present invention include that it facilitates easy correspondence of an event with a particular category such as: a family; a course of study; a holiday season; medical treatment; etc. This is achieved by a code. For example, in use for a medical treatment the calendar system can be used to display reoccurring treatments (such as weekly injections) as well as non-reoccurring events such as specialist appointments. Different types of information, such as appointments and treatments may be marked in a particular code for easy reference.

As shown in FIG. 1, in one embodiment of the present invention, a calendar system 10 may be formed of at least two pieces, at least one underlay piece 12 and an overlay piece 14. The underlay piece 12 may be interchangeable with other underlay pieces and more than one underlay piece may be incorporated in the calendar system. The underlay piece may display a calendar showing a specified period of time, for example, a year, a month, a day, or a date. The overlay piece 14 may have holes or windows 18 cut therein that correspond to the periods of time marked upon the underlay piece. The overlay piece 14 be placed on top of the underlay piece 12, whereby the two pieces together form a calendar system 10 capable of displaying and have recorded thereupon both reoccurring and non-reoccurring events.

The windows in the overlay piece may correspond to periods of time indicated upon the underlay piece. Additionally marking upon the overlay piece may correspond to periods of time related to those marked upon the underlay piece. For example, if the underlay piece is a calendar for a specific month, divided into days, the windows 18 in the overlay piece may correspond to the day divisions upon the calendar and the names of the days (Sunday, Monday, Tuesday, etc.) may be marked upon the overlay piece, as shown in FIG. 1. In FIG. 1 the underlay piece is marked with dates of a month, and the overlay piece indicates days in a consistent weekly format. When aligned the windows in the overlay piece correspond to the layout of the days marked on the monthly calendar of the underlay piece.

Furthermore, the underlay 12 and overlay 14 pieces may incorporate indicia sections 16 available for the inclusion of additional information or decorative indicia. One such section 16 may display information pertaining to the specific period of time displayed on the calendar, for example the name of the year, month, day, or date the underlay calendar displays. As shown in FIG. 1, indicia sections 16 may include a legend for any code applied in the calendar system, as well as an area for general notations, such as, for example, marking of emergency numbers, or other information.

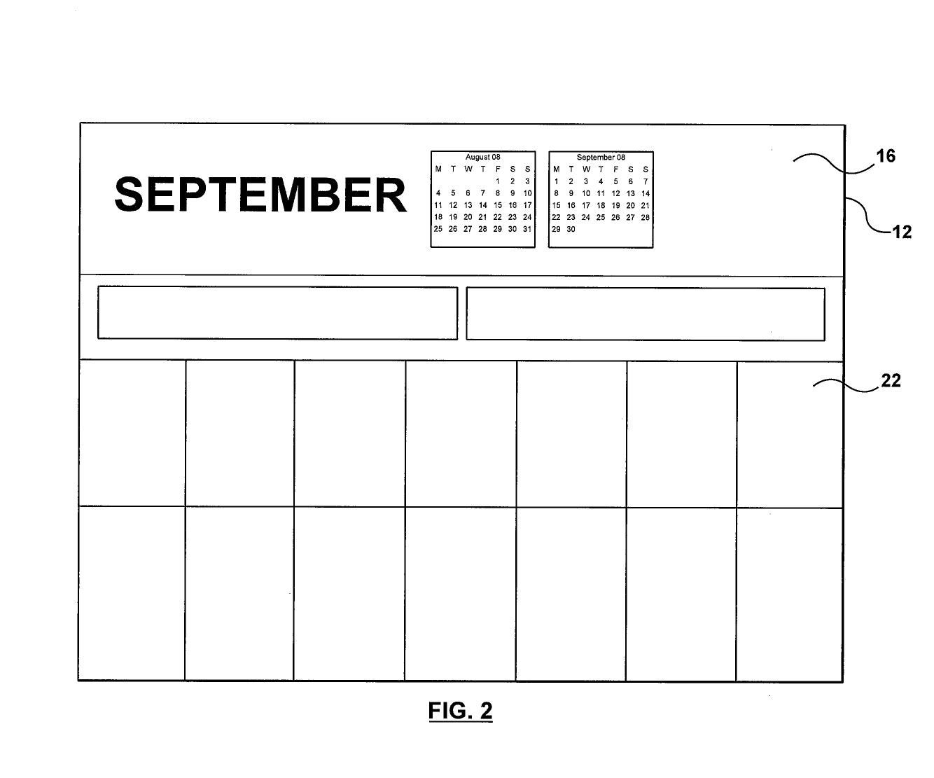

As shown in FIG. 2, in one embodiment of the present invention the underlay piece 12 may display a specific period of time, for example, a year, a month, a day, a date, etc., in a format printed on the underlay piece, such as, for example a calendar format. The underlay may be a standard calendar page printed in a known calendar format, or may have a tailored display format relating to periods of time. Each underlay page may display multiple periods of time. A longer period of time may be broken into shorter periods of time occurring within the overall period of time displayed on the calendar. For example, a year may be divided into months, a month may be divided into days (as shown in FIG. 2), a day may be divided into hours, etc. An underlay piece may display one or more of these periods of time. Generally, the periods of time displayed on underlay pieces may be displayed in a consistent format, such as, for example a regularly occurring layout that may be a table having rows and columns, so that each underlay piece display may be generally the same.

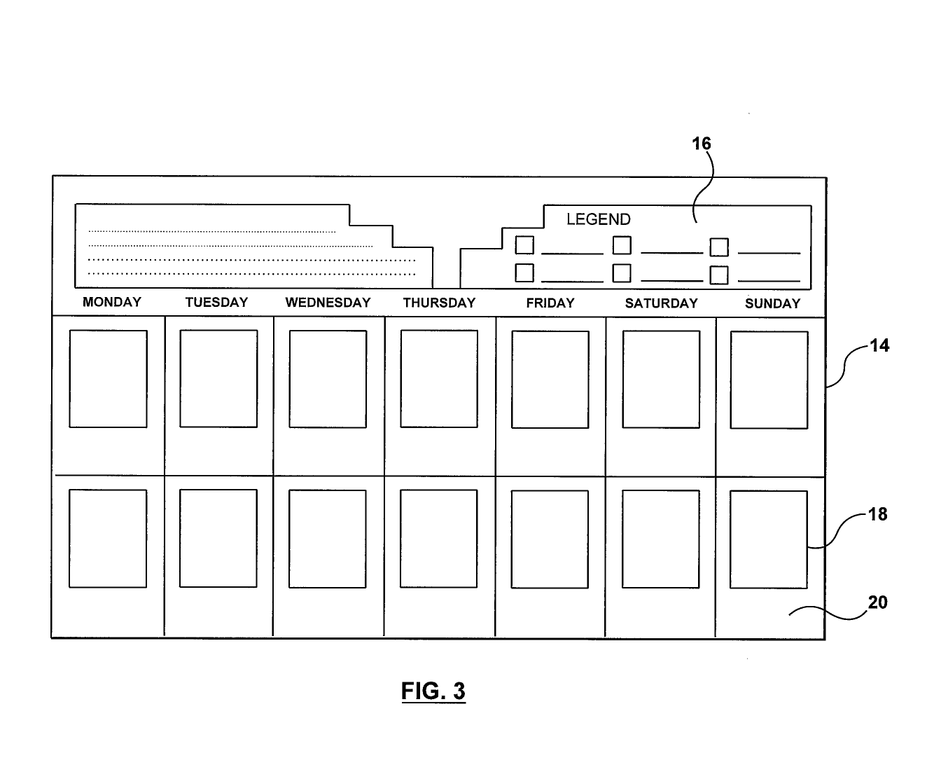

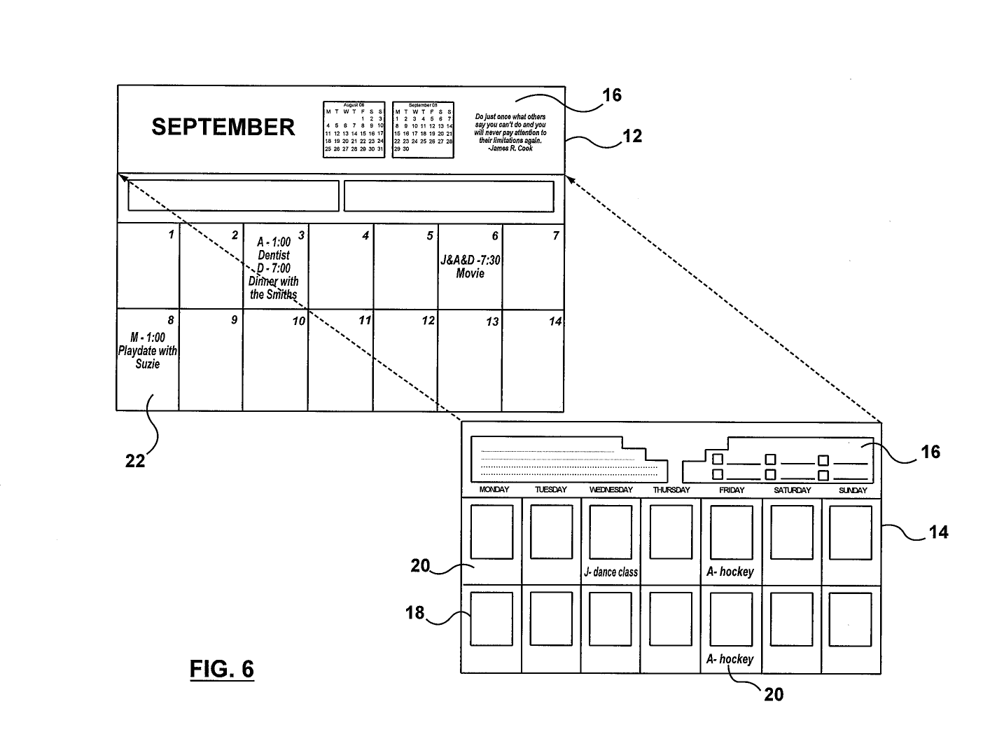

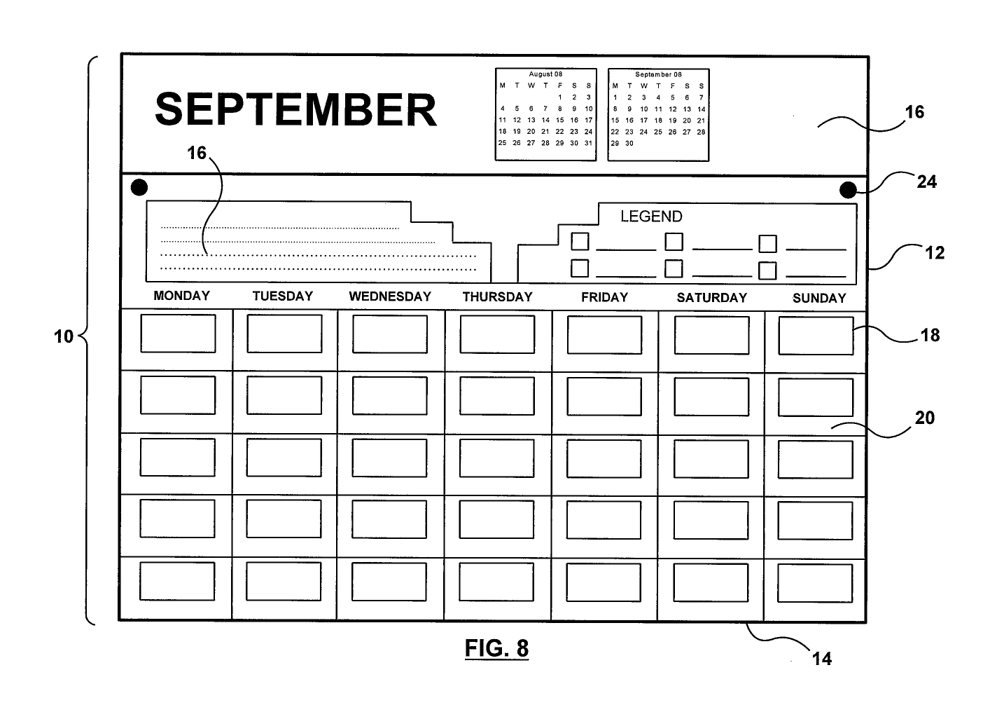

In one embodiment of the present invention, as shown in FIG. 8, the one or more underlay pieces may display a month of days. The layout of the underlay piece display may be four or five rows each having seven columns. Each column may correspond to one of each of the seven weekdays (e.g. Column 1 may correspond to Sunday, Column 2 may correspond to Monday, etc.). Each row may correspond to a week of days, each day representing a specific date (e.g. Row 1 includes Sunday, June 1st, Monday, June 2nd, Tuesday, June 3rd, Wednesday, June 4th, Thursday, June 5th, Friday, June 6th, and Saturday, June 7th). The overlay piece windows may be arranged in rows and columns that correspond to the layout of the underlay display. The overlay piece may be printed in a manner so as to correspond with the display of the underlay piece. For example, as shown in FIG. 3, the names of the days of the week may be printed on the overlay piece. The windows of the overlay piece may be of a size and layout whereby the date printed on the underlay display, if there is a date printed, may be visible and accessible through the window when the overlay piece and underlay piece are aligned, as shown in FIG. 6. If not date is printed on the underlay piece, then a blank area portion of the underlay piece may be visible and accessible through the window.

In one embodiment of the present invention, the underlay pieces may be a series of monthly calendar pages. The calendar months provided may cover any period of time, such as a calendar year, a school year, or months for a period of treatments. A skilled reader will recognize that other pages representing other periods of time may be applied in the present invention.

In another embodiment of the present invention, the underlay piece may be one of a series of twelve monthly calendar pages. Said pages may not have the dates written thereon. Thus, the calendar formatted pages may be utilized for any month of any year. The appropriate dates may be written in by the user.

As shown in FIG. 3, in one embodiment of the present invention, the overlay piece 14 may have windows 18 on its face. These windows correspond to the indication and layout of the smaller periods of time displayed upon the underlay piece 12. Moreover, spaces 20 upon the overlay piece 14 around the windows 18 allow for notations. These notations may include reoccurring events. A reoccurring event is one that occurs regularly upon the same period of time. For example, a reoccurring event may be a class that is taught every Thursday, or taking a medication at 2 pm and 4 pm every day. A skilled reader will recognize that a wide range of reoccurring events may exist and that the period of time of the calendar system may facilitate the easy notation of these upon the calendar system in a manner that does not require re-notation of the reoccurring event for another period of time when the event occurs.

When a new period of time occurs the underlay piece displayed may be changed. For example, as shown in FIG. 6, if the underlay piece shows the dates of the month of September, and the overlay piece has a reoccurring event marked thereon that occurs the second Friday of each month 20, such as, for example hockey practice, then changing the underlay piece to display dates in the month of October will cause the second Friday of the month of October to reflect the reoccurring event, namely the hockey practice. Alignment of the overlay piece, having the reoccurring event marked thereon, and underlay piece showing the days in the month of October will not require the user to mark the reoccurring event, namely the hockey practice, upon the dates when this occurs in October. The reoccurring event notation will be aligned with the dates when the underlay piece and overlay piece are aligned. When November, or subsequent months are displayed the reoccurring event notation will displayed as corresponding to the second Friday of those months as well.

In one embodiment of the present invention, the period of time displayed on the underlay piece may be divided into shorter period of time. For example, windows in the overlay piece may correspond with days of the week. Printing upon the underlay piece may cause each day shown within a window to be divided further into hours of the day. The area on the overlay piece 20 around the window 18, may offer space for multiple notations of reoccurring events corresponding to the shorter time period displayed upon the underlay piece and shown through the window of the overlay piece. For example, a hockey warm-up every second Friday of each month at 7 pm may be noted upon the overlay piece beside the window corresponding to the second Friday of the month and located to correspond to a marking of 7 pm upon the underlay piece as visible through the window. A second marking may also be made for the reoccurring event of a hockey game every second Friday at a position upon the overlay piece that corresponds to the window showing the second Friday of the month and located to correspond to a marking of 9 pm upon the underlay piece as visible through the window. A skilled reader will recognize that a variety of means of marking reoccurring events, including multiple reoccurring events, may be applied to the present invention calendar system.

In one embodiment of the present invention, the notation of reoccurring events may be erasable in a manner that permits new reoccurring events to be written in the same position where the prior reoccurring event notation appeared, whether the notation was made on the overlay piece or underlay piece. A user may thereby change reoccurring events to correspond to period during the time period reflected on the calendar system. For example, if the time period of the calendar system is months, then as the seasons change the reoccurring events may change. For example, the reoccurring event of hockey on the second Friday of a month may only last during the months of October through March. In April, a reoccurring event of ballet class may occur the second Friday of every month. The reoccurring event of hockey may be erased and the reoccurring event of ballet may be noted in its place.

As shown in FIGS. 3 and 6, access to the surface of the underlay piece may be achieved by way of the windows in the overlay piece when the calendar system is assembled. Assembly may be achieved when the overlay piece is positioned over top of the underlay piece and the windows of the overlay piece are aligned with the smaller periods of time displayed on the underlay piece. In an assembled state it may be possible for a user to write information upon the underlay piece 12 in the area exposed 22 through the window 18. For example, if the underlay piece includes a calendar for a month, the windows may be formed to correspond with days shown in the month calendar. Generally this exposed area 22 allows the information written thereon to correspond to a specific smaller period of time displayed on the calendar, for example, a month, a day, a date, an hour, etc. Further divisions within the smaller period of time are also possible, such that a day may be divided into hours as well, so that a play date a 13h00 on a particular day may be noted. The notations upon the underlay piece represent non-reoccurring events. These are events specific to the particular period of time shown on the underlay piece. For example, a dentist appointment occurring at 9 am on Friday, June 27^{th}.

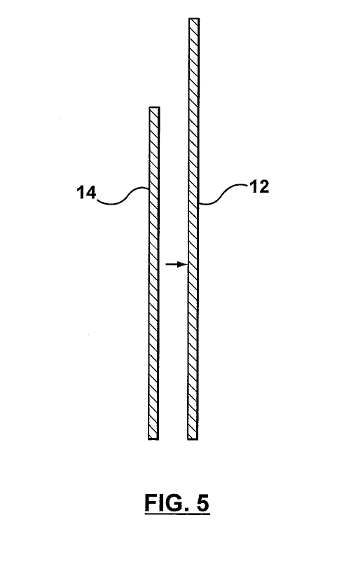

In one embodiment of the present invention, the underlay piece may be larger than the underlay piece so that information displayed on the underlay piece may be visible beyond the boundaries of the overlay piece when the calendar system is assembled. Consequently, assembly of the calendar system may involve positioning of at least one overlay piece and at least one underlay piece in a staggered manner, as shown in FIG. 5. A skilled reader will recognize that staggered positioning is not required in all embodiment of the present invention. A skilled reader will further recognize that staggering may be involve a variety of alignments of the windows of at least one overlay piece with the printing or other aspects of at least one underlay piece. As shown in FIG. 1, a section of the underlay piece displaying information specific to the period of time displayed, such as, for example the title of a month, may be printed on the area of the underlay piece and assembly of the calendar system may cause this to be visible. As shown in FIG. 9, one or more indicia sections may be printed on the underlay piece and assembly of the calendar system may allow this to be displayed. A skilled reader will recognize that other assemblies are possible for the present invention calendar system.

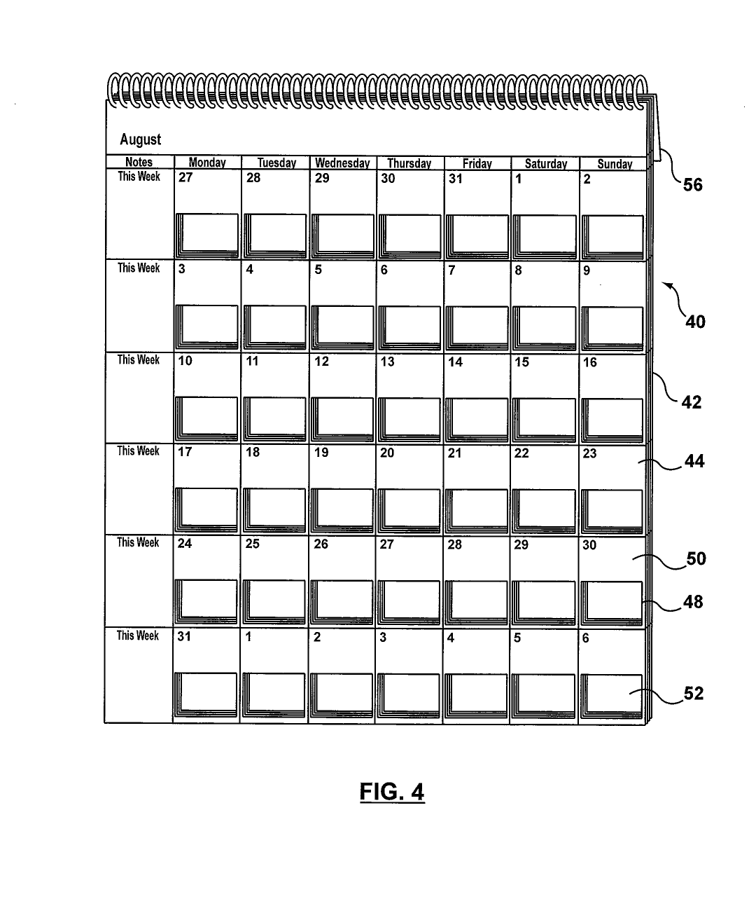

As shown in FIG. 4, in one embodiment the present invention of a calendar system 40 may be formed of at least two pieces, an underlay piece 42 and at least one overlay piece 44. The overlay piece 44 may be interchangeable with other overlay pieces and more than one underlay piece may be incorporated in the calendar system. The one or more overlay pieces may display specified period of time, for example, a year, a month, a day, or a date. The display may represent a calendar format. For example, the overlay piece may display a month and may further display dates relating to the days in the month. The one or more overlay pieces may have windows or holes cut therein corresponding to specified periods of time, such as, for example corresponding to each day in the month. The overlay piece and underlay piece when assembled together in an aligned manner, may form a calendar system 40 capable of displaying and have recorded thereupon both reoccurring and non-reoccurring events.

In one embodiment of the present invention, multiple overlay pieces 44 may be placed on top of the underlay piece 42. The windows of the overlay pieces may be aligned so that portions of the underlay piece are visible.

Portions of the underlay piece may be visible through the windows of the one or more overlay pieces. Events related to the categories of time displayed upon the overlay piece may be indicated upon the underlay piece. For example, if the overlay piece is marked with a calendar for a month and windows in the overlay piece correspond to the days of the month, then events may be indicated on the underlay piece pertaining to particular days of the month, as shown in FIG. 4. A hockey practice that is a reoccurring event every second Friday of a month may be marked upon the underlay piece in an area of the underlay piece that corresponds to the window for the second Friday of every month in the overlay piece, in a manner that causes the reoccurring event notation to be visible when the calendar system is assembled. A person skilled in the art will recognize that other types of time designations may be indicated upon the overlay piece, e.g. a months in a year, hours in a day, etc.

Marking on the underlay piece may be made by a user through access to the underlay piece provided by the one or more window of the overlay piece when the calendar system is assembled. Markings on the underlay piece may also be pre-printed thereupon prior to assembly of the calendar system. Markings may include reoccurring events, as well as subdivisions of periods of time indicated by the windows in the overlay piece into shorter periods of time. For example, if the overlay piece displays a period of time that is a month and includes windows indicating days in the month, the underlay piece may be marked to indicate hours within a day. Reoccurring event may be marked upon the underlay piece to correspond to a particular shorter period of time. One or more non-reoccurring events may be marked on the overlay piece in a manner that causes the non-reoccurring event to correspond to a shorter period of time marked upon the underlay piece. In the manner similar to that described above, markings of reoccurring events may be erasable and replaced or overwritten with new reoccurring event notations.

Non-reoccurring events may be marked upon the overlay piece. Multiple non-reoccurring events may be marked to correspond to a particular window in the overlay piece. Multiple non-reoccurring events corresponding to a particular period of time displayed on the overlay piece may further be marked upon the overlay piece to correspond to particular shorter periods of time than the period of time indicated by the window, if the underlay displays shorter period of time markings.

Access to, and visibility of, the surface of the underlay piece may be achieved by way of the windows when the calendar is assembled. When assembled the overlay piece is positioned over top of the underlay piece and the windows of the overlay piece may be aligned with any marking on the underlay piece, so that reoccurring events or other markings on the underlay piece may be visible through a corresponding window of the overlay piece. It may be possible to add event notations to the underlay piece before and after the calendar system is assembled. It may be possible for a user to write information, such as reoccurring events, upon the underlay piece 42 in the area exposed 52 through the window 48. The area on the overlay piece 50 around each window 48, may offer further space for additional notations of information, such as non-reoccurring events, relating to the period of times displayed on the overlay piece.

As shown in FIG. 6, the calendar system of the present invention may be assembled through the alignment of the underlay and overlay pieces. The overlay piece may be positioned over the underlay piece so that any markings, including event notations or periods of time marked on the underlay piece, are visible through the corresponding windows of the overlay piece. In one embodiment, the alignment may allow for a user to write upon the underlay piece without removing the overlay piece.

Following alignment at least one overlay piece and at least one underlay piece may be joined through a variety of attachment means. A mounting means may further be applied to mount the calendar system on a surface, such as a refrigerator door, or a wall. It is possible for the attachment means to perform the dual-purpose of further being utilized as a mounting means.

In one embodiment of the present invention, as shown in FIGS. 6 and 9, the calendar system may be assembled through the alignment of underlay and overlay pieces. FIG. 9 shows that the alignment may be fixed and/or secured by way of a spiral binding 58. In this embodiment overlay pieces may be flipped to display other overlay piece. Overlay pieces may be positioned behind the underlay piece when not required to be displayed. For example, if the overlay pieces display months of the year, once a particular month is over the overlay piece may be flipped to display the overlay piece displaying the required month. A skilled reader will recognize that the spiral binding may facilitate other configurations of the calendar system, such as, for example, the spiral binding may be affixed to any side of the calendar system, overlay and/or underlay pieces may be flipped, as well as other configurations. The spiral binding may further incorporate a section to facilitate integration of the binding with a mounting means, such as, for example a ring encompassing the wire of the spiral binding, or an indentation in the spiral binding, whereby the calendar system may be mounted for display purposes.

The calendar system of the present invention may be attached through other means as well so that the overlay and underlay pieces are positioned in alignment. For example, a variety of releasable means may be applied. Releasable attachment means are preferable, but a skilled reader will recognize that fixed attachment means may also be applied.

In one embodiment of the present invention, the attachment means may be a snap attachment means, such as, for example a nylon snap means. A female snap rivet mounted upon an overlay piece may be snapably attached to a male snap rivet mounted upon an underlay piece, or the snap rivets may be attached in a reversed fashion so that the female rivet attaches to the underlay piece and the male rivet attaches to the overlay piece.

In another embodiment of the present invention, the overlay and underlay pieces may be required to be displayed upon a metallic surface capable of attracting magnetic pull, such as a refrigerator. In such an embodiment, the underlay piece may be formed of some type of paper-like material, whereas the overlay piece may be constructed of magnetic material. The pull of the magnet may hold the underlay piece against the overlay piece and pull the overlay piece towards the refrigerator door. When the two pieces are aligned against a surface such as a refrigerator door, they may be held together in a releasably secure manner. The overlay piece and the surface may remain in near-contact with one another and thereby maintain a pull through proximity, so as to keep the assembled calendar displayed upon the surface without it falling-down.

In another embodiment of the present invention, holes may be formed in the overlay and underlay pieces to correspond with each other that are positioned to accommodate alignment of at least one underlay piece and at least one overlay piece when the calendar system is assembled. Said holes may be shaped so that posts connected to the surface where the assembled calendar is to be displayed may be fed through the holes, whereby said posts may releasably affix the calendar pieces in an aligned and assembled manner. It will be obvious to one skilled in the art that a hole and post configuration may function as an attachment means, as well as a mounting means. A skilled reader will also recognize that many different placements of the holes and posts may be applied to assemble and mount the calendar system for use and/or display.

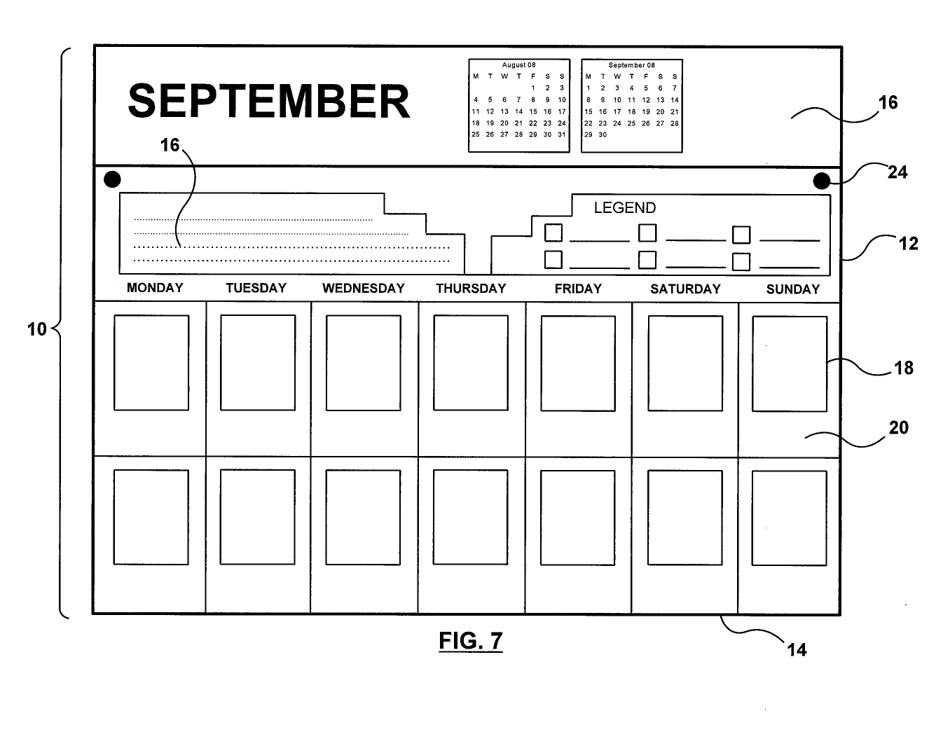

In still another embodiment of the present invention, a releasable means of securing the pieces upon the posts may be utilized, such as a weighted washer or washers. Alternatively, the posts may be screws and nuts may attach to the posts through compatible rotation, for the purpose of securing the pieces in a releasable manner. In yet another embodiment of the present invention, hooks may be secured to the surface upon which the assembled calendar is to be displayed. Holes corresponding to the placement of the hooks may be formed in each piece of the calendar system, the underlay and overlay pieces. When the two pieces are fitted onto the hooks the calendar system may be displayed in an aligned and assembled manner. As shown in FIG. 7, in another embodiment of the present invention, thumb-tacks 26 may also be applied to attach the overlay and underlay pieces to each other and further to a surface located behind the underlay piece. It will be appreciated by those skilled in the art that other variations of the means for holding at least one underlay piece and at least one overlay piece in an aligned and assembled manner may also be practiced without departing from the scope of the invention.

In yet another embodiment of the present invention, the overlay and underlay pieces may be releasably secured in alignment by way of an adhesive, such as sticky-tack, tape, Velcro™, or other materials whereby the pieces will be held together in a manner that permits them to be detached later without damage to the overlay piece. In another embodiment of the present invention, as shown in FIG. 4, a hanging tab 56 may be incorporated into the calendar system whereby the calendar system may be mounted for display.

The present invention may incorporate either multiple overlay pieces or multiple underlay pieces, depending on the embodiment. Reoccurring events may be marked upon a single piece, whether an overlay piece or an underlay piece, in a manner that corresponds with a window of an overlay piece that indicates a specific period of time. The piece having one or more reoccurring events marked thereon may be that may be utilized in conjunction with other multiple pieces and aligned therewith to indicate the timing of a reoccurring event within a specified period of time. Either an underlay piece or an overlay piece will be the piece that at least one reoccurring event is marked upon. For example, if at least one reoccurring event is marked on an overlay piece, then multiple underlay pieces may be incorporated in the calendar system, whereas if at least one reoccurring event is marked on an underlay piece then multiple overlay pieces may be incorporate in the calendar system.

The multiple pieces, be these either overlay pieces or underlay pieces, may indicate specific periods of time, such as, for example, a dates in a particular month and year, such as October 2009. The multiple pieces may therefore be exchanged pieces showing other specific periods of time, for example, dates in another month, such as November 2009. The multiple pieces may be created to have the same layout, which is a layout that corresponds to the layout of the piece having at least one reoccurring event marked thereupon, and therefore exchanging one multiple piece for another multiple piece will not affect the function of the calendar system. Any reoccurring event marked upon a piece will correspond to any of the multiple pieces once the reoccurring event piece and the multiple piece are aligned.

Non-reoccurring events can be indicated upon the multiple pieces directly, either while the calendar system is assembled or when the calendar system is unassembled.

In one embodiment, either the underlay piece, or the overlay piece, or both of the pieces may further be covered with laminate or other plastic coating or covering, so that any marking thereupon, may be removable, should an reoccurring or non-reoccurring event be cancelled or replaced or should a reoccurring event become non-reoccurring.

In one embodiment of the present invention, the overlay piece, underlay piece, or both may be preprinted. Reoccurring and/or non-reoccurring events may be printed thereon that are chosen by the user or any other person. The user may mark additional reoccurring or non-reoccurring events upon either the overlay piece or the underlay piece, depending on the embodiment of the calendar system, to supplement the preprinted events. Preprinting may be useful for many purposes, such as, for example creating a course calendar for educational institutions, providing a patient with a medical treatment regime reminder, indicating regular meetings of an association to its members, etc. A skilled reader will recognize that several uses of the calendar system as a preprinted delivery are possible.

It will be appreciated by those skilled in the art that other variations of the embodiments described herein may also be practiced without departing from the scope of the invention. Other modifications are therefore possible. For example, the calendar may be a type other than a wall calendar, for example a bound calendar, a perpetual calendar, or a wheel-displayed calendar.

1. A reoccurring event calendar system comprising:
(a) at least one underlay piece;
(b) at least one overlay piece having one or more windows therein, said one or more windows corresponding to periods of time, the at least one overlay piece being positioned over the at least one underlay piece so that portions of the at least one underlay piece are accessible through the one or more windows; and
(c) a marking means for marking one or more reoccurring events to correspond to the periods of time by:
(i) marking the one or more reoccurring events on the at least one underlay piece to be visible through at least one of the one or more windows; or
(ii) marking the one or more reoccurring events one the at least one overlay piece to correspond to at least one of the one or more windows;
whereby the one or more reoccurring events correspond to a period of time.

2. The calendar system of claim 1, wherein the one or more reoccurring events are marked in accordance with a code.

3. A reoccurring event calendar system comprising:
(a) one or more underlay pieces having a calendar printed thereon; and
(b) an overlay piece having one or more windows corresponding to the calendar of the underlay piece and providing one or more areas corresponding to the one or more windows capable of having markings of one or more reoccurring events made thereon corresponding to the one or more windows;
whereby the one or more marked reoccurring events correspond to the calendar printed on the one or more underlay pieces when the overlay piece is positioned over at least one of the one or more underlay pieces and aligned therewith.

4. The calendar system of claim 3, wherein portions of the underlay piece are accessible through the one or more windows when the overlay piece is aligned with at least one of the one or more underlay pieces and one or more non-reoccurring events may be marked on the underlay piece by access through the one or more windows.

5. The calendar system of claim 3, wherein the one or more underlay pieces are one or more monthly calendar pages and the one or more windows of the overlay piece correspond to the format and layout of the one or more calendar page;

6. The calendar system of claim 3, wherein the one or more reoccurring events are marked in accordance with a code.

7. The calendar system of claim 3, wherein one or more of, the overlay and the one or more underlay pieces, include indicia sections.

8. The calendar system of claim 3, wherein the overlay and at least one of the one or more underlay pieces are held as aligned by an attachment means.

9. The calendar system of claim 8, wherein the attachment means is an adhesive.

10. The calendar system of claim 8, wherein the attachment means is one of the following:
(a) an attachment means that releasably attaches the calendar system to a third surface;
(b) a spiral binding; or
(c) one or more hooks attached to the third surface fitted through holes formed in the overlay piece and the one or more underlay pieces.

11. The calendar system of claim 3, wherein the overlay piece is formed of magnetic material and the overlay piece and one or more underlay pieces may be held in alignment by way of magnetic pull between the overlay piece and a third surface positioned behind the underlay piece.

12. A reoccurring event calendar system comprising:
(a) one or more overlay pieces having a calendar printed thereon and having one or more windows corresponding to the calendar; and
(b) an underlay piece capable of having markings of one or more reoccurring events made thereon positioned to be visible through at least one of the one or more windows when at least one of the overlay pieces is positioned over the underlay piece and aligned therewith;
whereby the marking of the one or more reoccurring events correspond to the calendar printed on the one or more overlay pieces.

13. The calendar system of claim 12, wherein reoccurring events are be marked in accordance with a code.

14. The calendar system of claim 12, wherein the one or more underlay pieces and the overlay piece may include indicia sections.

15. A method of utilizing a reoccurring event calendar system comprising the steps of:
(a) marking one or more reoccurring events upon an overlay piece to correspond with one or more windows therein;
(b) aligning at least one underlay piece having a calendar printed thereon with the overlay piece so that the one or more reoccurring events marked upon the overlay piece correspond to the calendar printed upon the underlay piece; and
(c) viewing the one or more reoccurring events marked upon the overlay piece as corresponding to the calendar of the at least one underlay piece visible through the one or more windows of the overlay piece.

16. The method of claim 15, comprising the further step of marking one or more of the one or more reoccurring events in accordance with a code.

17. The method of claim 15, comprising the further step of marking one or more of the following:
(a) one or more non-reoccurring events upon the underlay piece so that the one or more non-reoccurring events are visible through the one or more windows of the overlay piece; or
(b) one or more additional reoccurring events upon the overlay piece.

18. The method of claim 15, comprising the further step of attaching the aligned overlay and at least one underlay piece to a third surface in a releaseable manner.

19. A method of utilizing a reoccurring event calendar system comprising the steps of:
(a) receiving at least one overlay piece having a calendar printed thereon and windows therein corresponding to the calendar;
(b) marking one or more reoccurring events upon an underlay piece to correspond with one or more windows therein so as to be visible through at least one of the one or more windows;
(c) aligning at least one of the one or more overlay pieces with the underlay piece so that the one or more reoccurring events marked upon the overlay piece correspond to the calendar printed upon the underlay piece; and
(d) viewing the one or more reoccurring events marked upon the underlay piece as corresponding to the calendar of the at least one underlay piece visible through the one or more windows of the overlay piece.

20. The method of claim 19, comprising the further step of marking one or more of the following:
(a) one or more non-reoccurring events upon the at least one overlay piece to correspond to the one or more windows of the overlay piece; or
(b) one or more additional reoccurring events upon the underlay piece by accessing the underlay piece through the one or more windows so that the one or more additional reoccurring events are visible through the one or more windows of the overlay piece and correspond to the calendar of the at least one overlay piece.
